(19) United States
(12) Patent Application Publication
(10) Pub. No.: US 2010/0072196 A1
(43) Pub. Date: Mar. 25, 2010

(54) CONTROLLED VENTING FOOD PACKAGE

(76) Inventors: Adam Avis, Little Elm, TX (US); Eduard Edwards, Arlington, TX (US); Joe Sagel, Plano, TX (US); David Miller, Coppell, TX (US)

Correspondence Address: CARSTENS & CAHOON, LLP, P O BOX 802334, DALLAS, TX, 75380, US

(21) Appl. No.: 12/237,056

(22) Filed: Sep. 24, 2008

(51) Int. Cl. H05B 6/80; B65B 51/02

(52) U.S. Cl. 219/730; 53/416

(57) ABSTRACT

A food package that controllably vents when heated in the microwave, and method of making the same, is provided. A microwave susceptor is provided to heat-weaken a sealant or wall during microwave heating and allow the seal to controllably fail. The susceptor can be attached to the food package as an adhesive tab, incorporated directly into the food packaging material, or incorporated into a flexible sleeve around the food package. Optionally, flap guards can be provided as part of the flexible sleeve to guard against the ejection of food particles from the package when the seal fails.

### BACKGROUND OF THE INVENTION

1. Technical Field

The present invention relates to a food package that vents in a controlled manner when it is heated in a microwave and method of making the same.

2. Description of Related Art

The snack food industry markets some snack foods in food packages that comprise a base and a lid sealed onto the base. The base generally comprises a bowl or other liquid retaining shape with a rim, and a lid is typically sealed along the rim of the base. Foods that are sold in such packaging include chili, soup, cheese sauce, salsa, dips and other mixtures of solid and/or liquid food products. Foods that are packaged in this way are often consumed directly from the base after the lid is removed.

Additionally, many such packaged foods are intended to be consumed at elevated temperatures, and the most convenient method of heating them is in a microwave oven. The microwave oven is an appliance that can be found in many homes and businesses. During operation, a microwave oven floods the cooking chamber with non-ionizing microwave radiation, usually at a frequency of about 2.45 GHz. Many food molecules (for example water molecules) are electric dipoles, which means they are positively charged at one end and a negatively charged at the other end. As the microwave radiation passes through the food, the dipole molecules rotate as they try to align themselves with the alternating electric field of the microwaves. This rotation and movement causes the food to heat up as the rotating molecules impact other molecules, putting them into motion. Microwave heating is highly efficient on liquid water (which a relatively polar molecule), and much less so on fats and sugars (which are less polar).

However, placing into a microwave and heating a scaled food package described above with a water-containing food or food product inside causes serious problems. Most such packaged foods are packaged with a “headspace.” The headspace is the region between the food inside the food package and the lid. The headspace will absorb moisture from the food inside the package, and during microwave heating the air in the headspace tends to heat up very quickly. This heated air, in turn, expands and increases the pressure level inside the food package. Once enough pressure had built up inside the food package to a large enough degree, the sealant between the lid and the base fails rapidly and the food package vents uncontrollably. The result is usually a loud, explosion-like sound accompanied by the ejection of food from the package and onto the walls of the microwave oven.

The main solution to this problem in the prior art is to provide instructions to the consumer to vent the food package before heating it in the microwave. This approach is problematic for several reasons. First, the consumer may not vent the food package as instructed because he or she did not read, forgot to follow, or chose not to follow the instructions provided. Second, in the case of several different food product packages being bundled and sold together with the intention of being heated and consumed together, the consumer would be required to disassemble the food package bundle, vent each food package individually, and reassemble the bundle before heating them together. In any case, the consumer is inconvenienced by this prior art solution.

Consequently, a need exists for a food product package that vents in a controlled manner when heated in a microwave oven.

### SUMMARY OF THE INVENTION

The present invention places a microwave susceptor in radiant communication with the lid used to seal the food package. In one embodiment, the susceptor heats and weakens the sealant that holds the lid onto the base at a predetermined location, allowing the failure of the lid during microwave heating to occur in a controlled fashion. In a preferred embodiment, the susceptor is placed on top of the material that comprises the food package above the sealant via an adhesive microwave susceptor tab. In another embodiment, the susceptor is incorporated into the food packaging material adjacent to the sealant. In still another embodiment, the susceptor is located on or integral to the lid at a location within a perimeter defined by the sealant. In another embodiment, the food package comprises a flexible sleeve incorporating a microwave susceptor in radiant communication with the lid and/or sealant.

Optionally, in one embodiment, at least one flap guard can be included at the edge of the food package, as a part of the flexible sleeve, near the susceptor. Including a flap guard further reduces the likelihood that the venting food package will spray food particles onto the walls of the microwave.

The resultant food product package is relatively simple and inexpensive to manufacture, yet overcomes the problems in the prior art by allowing the food package to vent in a controlled fashion during heating in a microwave oven. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a prior art food package;

FIG. 2 is a perspective view of one embodiment of the present invention comprising a microwave susceptor adhesive tab placed on the food package lid;

FIG. 3 is a perspective view of a microwave susceptor adhesive tab that can be used in accordance with the present invention;

FIG. 4 is a perspective view of one embodiment of the present invention comprising a susceptor integral to the food package lid;

FIG. 5A is a perspective view of one embodiment of the present invention comprising a susceptor integral to the food package base;

FIG. 5B is another perspective view of one embodiment of the present invention comprising a susceptor integral to the food package base;

FIG. 6 is a perspective view of one embodiment of the present invention comprising a susceptor integral to or adhered to the lid at a location within a perimeter defined by the sealant;

FIG. 7 is a perspective view of one embodiment of the present invention comprising a flexible sleeve surrounding the food package and incorporating a susceptor;

FIG. 8 is a perspective view of one embodiment of the present invention comprising flap guards extending from the flexible sleeve surrounding the food package.

### DETAILED DESCRIPTION OF THE PREFERRED EMBODIMENTS

The present invention is directed towards a food package that, when heated in a microwave, vents in a controlled fashion, and method of making the same. The term “food package” as used herein is defined as a package designed to contain food inside of it. In its broadest sense, the “package” portion of the food package generally comprises at least one wall and at least one seal. The type of food package that usually undergoes microwave heating before the food inside is consumed comprises a sturdy, bowl-shaped base with a lid sealed to the rim of the base. However, the principles of the present invention in its broadest sense are applicable to any food package containing a seal that is likely to rupture in an uncontrolled fashion while the food inside is being heated by a microwave oven.

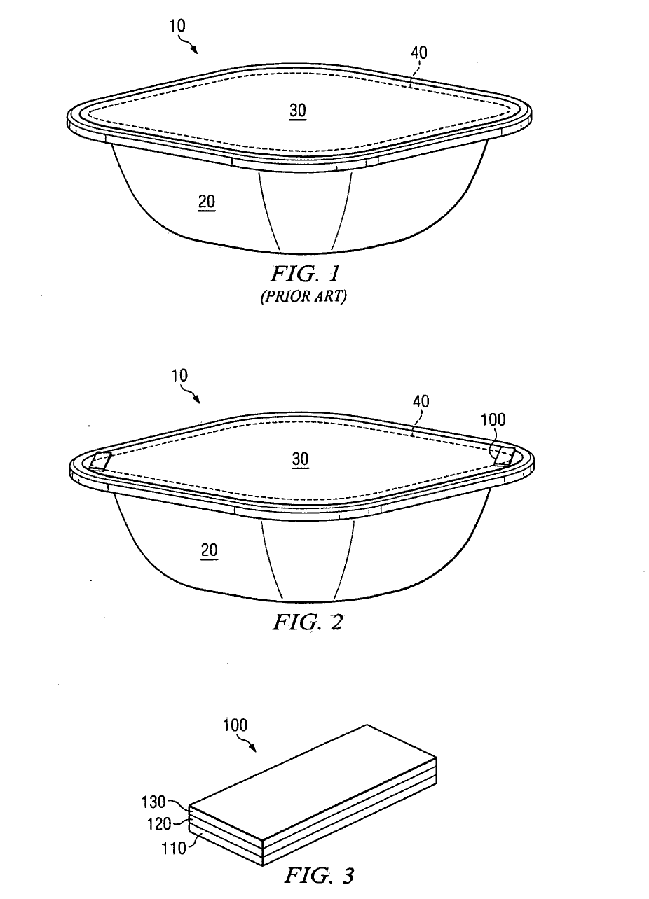

Referring to FIG. 1, therein is depicted a prior art food package 10 that, when heated inside a microwave with food inside the package, will uncontrollably and violently vent. The food package 10 comprises a bowl-shaped base 20, a lid 30 and a seal 40 holding the lid 30 onto the base 20 along its rim. In this embodiment, the base 20 and lid 30 comprise the walls of the package. The seal can be created using any heat activated sealant known in the industry, including polypropylene based sealants.

Many commercial food processors subject food packages to a retort process in order to sterilize the package and the food inside. During the retort process, the food package is heated to temperatures between about 250° F. and about 260° F. for at least 30 minutes. The seal 40 created by most retort grade heat activated sealants used in the food packaging industry, therefore, is typically capable of surviving the high temperatures and potential pressure spikes that can occur during sterilization procedures. The seal 40 is so strong that, when it does fail during microwave heating, it tends to fail violently and uncontrollably due to the high levels of heat and pressure that have built up inside the headspace of the food package. This violent and uncontrolled failure is typically accompanied by a loud explosion or popping sound, and in some cases by the ejection of food from the food package at the point of failure. Experimental results have shown that the violent failure of the food packaging seal can occur after about 30 seconds to about 45 seconds of heating.

The present invention allows food packages that would otherwise suffer uncontrolled venting during microwave heating to vent in a controlled fashion. Controlled venting is accomplished by providing a microwave susceptor as a part of the food package on or near one wall of the food package, preferably the lid, which causes the lid to fail at a known location before substantial heat and pressure have built up inside the headspace of the food package. A microwave susceptor, as that term is used herein, is defined as a material that has the ability to absorb microwave radiation and convert it into heat. This heat is then transferred to any surface adjacent to or near the susceptor, causing that surface to heat up. Conversion of microwave energy to heat in this maimer has been used for microwave heating foods which require crust browning, such as frozen pizzas. Microwave susceptor materials that can be used in accordance with the present invention are well known in the art, and are described in U.S. Pat. Nos. 5,107,089 and 4,833,007 (the disclosures of which are incorporated herein by reference) among many others.

The susceptor is typically gray or blue-gray in color, and is usually made of ceramics or metals (aluminum, nickel, antimony, copper, molybdenum, iron, chromium, tin, zinc, silver, gold, and various alloys of these metals) or both. In one embodiment, the susceptor is created by physical vapor deposition of aluminum onto a polyester film. Physical vapor deposition is a method of depositing aluminum onto polyester film that is generally well known in the industry. However, many different types of metals and ceramics and polymer films can be used to create a susceptor that can be used in accordance with the present invention.

In the present invention, this heat energy radiated by the susceptor is used to weaken the lid at a specific location. In one embodiment, the susceptor location corresponds to the sealant that holds the lid onto the base, and weakens the lid's adherence to the base by heat weakening, or softening, the sealant between the lid and the base. Thus, the susceptor is in radiant communication with the sealant. In another embodiment, the susceptor is in radiant communication with the lid, thereby causing a portion of the lid to melt and controllably fail. As used herein, the term “radiant communication” between a susceptor and a sealant or a lid is defined as the orientation of the susceptor and the sealant or lid being such that heat radiates (or transfers, typically by conduction) from the susceptor surface to the sealant or lid as the susceptor absorbs microwaves. For a seal created using a polypropylene based sealant, typically the sealant will controllably fail when it is heated to a temperature above 280° F., and preferably to a temperature between about 280° F. and about 300° F. At the time of controlled failure, the pressure inside the food package is, in one embodiment, between about 1 psi and 15 psi. For other types of heat activated sealants, and for different types of polymer films used to make the lid, different temperatures and pressures may be required to weaken it enough to allow it to fail in a controlled fashion.

FIG. 2 depicts one embodiment of the present invention. In this embodiment, the susceptor comprises an adhesive susceptor tab 100 that is physically attached to the top of the lid 30 along the rim of the base 20 at a location over the sealant 40. In a preferred embodiment, 20 the adhesive susceptor tab 100 susceptor is placed onto the food package 10 after the package 10 has already undergone the retort process to minimize the possibility of it becoming dislodged during retort. If the lid 30 is circular in shape, the adhesive susceptor tab 100 may generally be placed in any location along the rim and above the sealant 40. If the lid 30 has straight edges with rounded corners (as depicted in FIG. 2), it is preferable to place the susceptor adhesive susceptor tab 100 near the rounded corners so the consumer may use the vented corner as a starting place to remove the entire lid 30 after the food package 10 has been fully heated in the microwave. In this embodiment, during microwave heating the susceptor 100 will radiate heat down through the lid 30 and heat-weaken the sealant 40 as described above.

FIG. 3 depicts one embodiment of the adhesive susceptor tab 100 described above. The adhesive susceptor tab 100 shown therein comprises an adhesive layer 110, a susceptor layer 120, and optionally an insulating layer 130. Thus, the adhesive susceptor tab 100 should be affixed to the lid 30 such that the susceptor surface that radiates heat 120 faces the sealant 40. In a preferred embodiment, an insulating (or non-susceptor) layer 130 comprises the side of the adhesive susceptor tab 100 opposite the adhesive side 110 so the consumer's fingers are not burned when grasping the rim of the heated food package 10. The insulating layer 130 should not be made of any material that absorbs microwaves and inhibits the functionality of the susceptor layer 120.

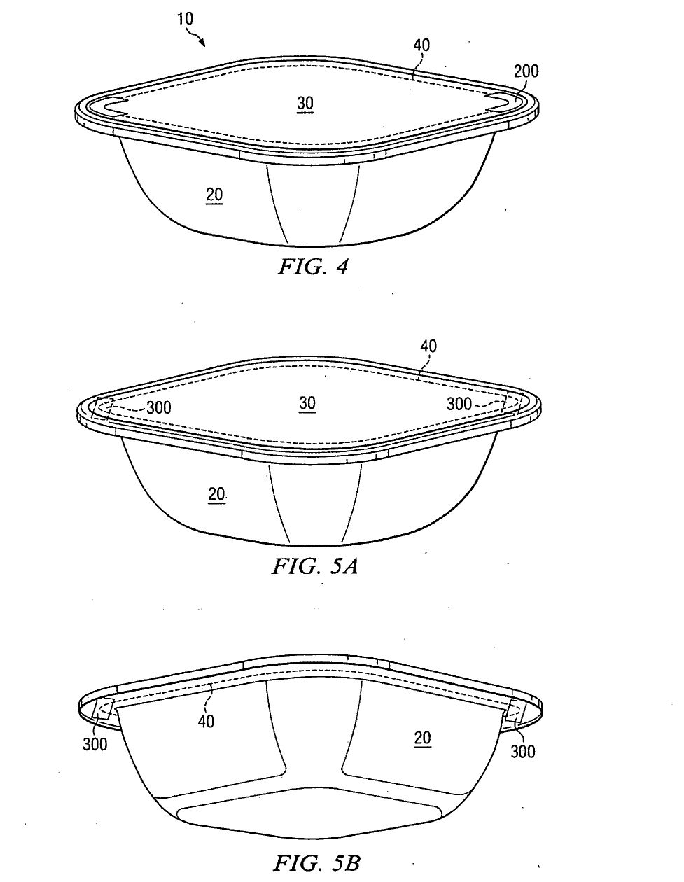

FIG. 4 depicts another embodiment of the present invention. In this embodiment, the susceptor 200 is integral to the lid 30 at a location along the rim of the base and in contact with the sealant 40. The advantage this embodiment has over the previous embodiment is that the susceptor 200 is located in closer proximity to the sealant 40, which allows the susceptor to more efficiently heat weaken the sealant 40 and cause the food package 10 to vent controllably. The disadvantage associated with this embodiment is that manufacturing an application specific lid with an integral susceptor located along the rim is more expensive than manufacturing a versatile adhesive susceptor tab that could be placed on many different types of food packaging and at different locations on the food package.

FIGS. 5A and 5B depict still another embodiment of the present invention. This embodiment involves providing a susceptor 300 that is integral to the base 20 along its rim and in contact with the sealant 40. The advantages and disadvantages of this embodiment mirror those of the embodiment that provides a susceptor 200 embedded into the lid 30. The overarching principle of the previous two embodiments is that the susceptor may be incorporated into the material that makes up the food package at a specific location adjacent to the sealant used to seal the food package.

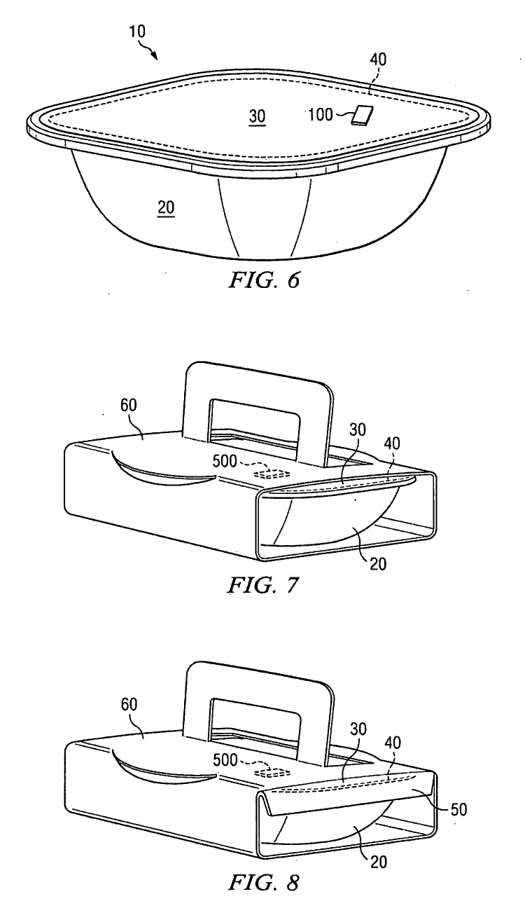

FIG. 6 depicts another embodiment of the present invention. In this embodiment, the susceptor is either integral to, or adhered to, the lid 30 at a location on the lid inside the perimeter created by the sealant 40, and above the food in the base 20. In the embodiment depicted in FIG. 6, the susceptor is an adhesive tab 100 adhered to the lid inside the perimeter created by the sealant 40. In this embodiment, heat from the susceptor melts through the polymer material comprising the lid 30, thereby causing a controlled failure of the lid and creating a vent. In a preferred embodiment, at least a portion of the susceptor made integral to, or adhered to, the lid 30 is made of a material that is not a microwave susceptor, thereby reducing the risk that the entire susceptor will melt through the lid 30 and fall into the food bowl 20 during heating.

The embodiments depicted in FIGS. 4, 5A, 5B and 6, wherein the susceptor is integral to the packaging material, tend to be more efficient when in use, but can be more difficult and expensive to produce. For example, to make lidstock that is compatible with the embodiment depicted in FIG. 4, a multilayered polymer film can be utilized. At least one of the interior surfaces of at least one layer of the multilayered polymer film can be selectively metallized in specific areas. The metallized areas can be chosen to correspond with the sealant 40, as in FIG. 4, or with an interior portion of the lid 30, as in FIG. 6. Similarly, in FIGS. 5A and 5B, a portion of the material comprising the base 20 can be metallized in the area where the sealant 40 adheres the lid 30 to the base 20.

FIG. 7 depicts another embodiment of the present invention. Here, the food package 10 is covered by a flexible sleeve 60. The flexible sleeve 60 comprises a microwave susceptor 500 designed to emit heat from an interior surface of the flexible sleeve 60 towards the sealant 40 or towards a portion of the lid 30 within the perimeter defined by the sealant 40. In this embodiment, during microwave heating a vent is created in the lid 30 or the sealant 40 at a location corresponding to the location of the microwave susceptor 500. In a preferred embodiment, the flexible sleeve 60 comprises paperboard.

FIG. 8 depicts one embodiment comprising an optional feature of the food package of the present invention. This embodiment also comprises a flexible sleeve 60 around the food package. This embodiment provides at least one flap guard 50 located along the outer edge of the flexible sleeve 60 at a location adjacent to the susceptor. The flap guard 50 is an extension of the flexible sleeve 60 and is bent towards the food package 10 at an angle. The angle between the flexible sleeve 60 and the flap guard 50 is preferably about 90°, but the flap guard 50 still functions at angles less than 180°. The flap guard 50 helps prevent food from being ejected from the food package 10 and flexible sleeve 60 when the sealant 40 or lid 30 suffer the controlled failure described above in connection with the microwave susceptor.

What is claimed is:

1. A method for making a food package, said method comprising the steps of:
providing a food package comprising at least one wall and at least one seal, wherein said at least one seal comprises at least one sealant;
providing at least one microwave susceptor; and
locating said at least one microwave susceptor in radiant communication with at least one of said at least one wall said at least one sealant;

2. The method of claim 1 wherein said locating further comprises affixing at least one microwave susceptor adhesive tab onto said food package.

3. The method of claim 1 wherein said locating further comprises incorporating said at least one microwave susceptor into said at least one wall.

4. The method of claim 1 wherein said food package further comprises a base and a lid affixed to said base by said seal.

5. The method of claim 4 wherein said locating further comprises incorporating said microwave susceptor into said lid.

6. The method of claim 4 wherein said locating further comprises incorporating said microwave susceptor into said base.

7. The method of claim 1 wherein said providing said microwave susceptor comprises physical vapor deposition of aluminum onto polyester film.

8. The method of claim 1 wherein said locating further comprises providing a flexible sleeve around said food package, wherein said flexible sleeve comprises said at least one of said at least one microwave susceptor.

9. The method of claim 8 wherein said providing said flexible sleeve further comprises providing said flexible sleeve with at least one flap guard.

10. A food package comprising:
at least one wall;
at least one seal comprising at least one sealant; and
at least one microwave susceptor in radiant communication with at least one of said at least one wall and said at least one sealant;

11. The food package of claim 10 wherein said at least one wall comprises a base and a lid affixed to said base by said seal.

12. The food package of claim 10 wherein said at least one microwave susceptor comprises at least one microwave susceptor adhesive tab.

13. The food package of claim 10 wherein said at least one microwave susceptor is integral to said at least one wall.

14. The food package of claim 11 wherein said microwave susceptor is integral to said lid.

15. The food package of claim 11 wherein said microwave susceptor is integral to said base.

16. The food package of claim 10 further comprising:
a flexible sleeve around said food package comprising at least one of said at least one microwave susceptor.

17. The food package of claim 16 wherein said flexible sleeve further comprises at least one flap guard bent towards said food package at an angle less than 180°.

18. The food package of claim 17 wherein said angle is about 90°.

19. The food package of claim 10 wherein said microwave susceptor comprises at least one of aluminum, nickel, antimony, copper, molybdenum, iron, chromium, tin, zinc, silver, gold and ceramic.
